(19) United States
(12) Patent Application Publication
(10) Pub. No.: US 2012/0252938 A1
(43) Pub. Date: Oct. 4, 2012

(54) MODIFIED ASPHALT PRODUCT AND PROCESS

(76) Inventors: Michael DES JARLAIS, YAKIMA, WA (US); Karen S. HYATT, YAKIMA, WA (US)

(21) Appl. No.: 13/434,698

(22) Filed: Mar. 29, 2012

Related U.S. Application Data
(60) Provisional application No. 61/516,207, filed on Mar. 30, 2011.

(51) Int. Cl. C09D 195/00

(52) U.S. Cl. 524/62; 106/273.1

(57) ABSTRACT

An asphalt modifying binder product, which is essentially a ‘cut-back’ bituminous binder, uniquely including a petroleum product, such as diesel fuel or alternatively an organic oil, including vegetable or animal derived fats or oils, or glycol, for use in the manufacture of cold mix asphalt “CMA” and asphalt treated base products. When mixed with an aggregate, the product blends within standard gradation ranges. The product may be employed as a patching/paving material or an asphalt treated base, either of which stays pliable for extended periods of time, and again meets the typical required specifications and standards, for stability, flow and voids, when tested as hot mix asphalt or asphalt treated base.

This Non-Provisional Application claims priority to Provisional Patent Application Ser. No. 61/516,207, filed Mar. 30, 2011.

### TECHNICAL FIELD

The invention relates to a stable and pliable, modified asphalt product, and a process for its manufacture. Specifically, the product includes a binder mixed with organic oils, tallows and/or glycerol, polymeric and paraffin adjuncts, along with ‘cut-back’ agents.

### BACKGROUND OF THE INVENTION

Hot mix asphalt or “HMA” is an engineered material, primarily used in road and parking areas for vehicles. In general, there are two ingredients to HMA: aggregates and liquid asphalt. Aggregates can be in the form of stone, gravel or sand. The selection of which single or combination of aggregates used in a given mixture of HMA, depends on the specifications needed and what is available, locally.

In general, aggregates represent approximately 95% of the total weight of an HMA product. The remaining 5% of HMA weight comprises a liquid asphalt, which is also referred to as ‘asphalt cement’ or simply ‘asphalt.’ Asphalt functions well as a waterproof, thermoplastic, and visco-elastic adhesive for the aggregate. Essentially, the asphalt functions as a glue, to hold the product together in use. For engineering specifications, as utilized by those persons skilled in HMA production, the American Society for Testing and Materials “ASTM D” defines an asphalt cement as a ‘fluxed’ or ‘unfluxed’ asphalt, specially prepared as to quality and consistency for direct use in the manufacture of ‘bituminous’ pavements, with bitumen defined as a class of black or dark-colored, solid or liquid cementitious substance, either natural or manufactured that is composed principally of high molecular weight hydrocarbons, of which tars, pitches, and ‘asphaltenes’ are typical constituents. Furthermore, a flux is generally defined as a bituminous material, typically liquid, that is used for softening other bituminous materials.

Cold mix asphalt “CMA” is produced either by emulsifying the asphalt in water with a soap material prior to mixing the asphalt with the aggregate, or by adding a ‘cut-back’ material, as discussed below. While in its emulsified state, the asphalt is less viscous and the mixture and is relatively easy to work with and compact. The emulsion will break down after enough water evaporates and ideally, the CMA will take on the properties of cold HMA. CMA is commonly used as a patching material and on lesser trafficked roads and paths.

A ‘cut-back’ asphalt is generally known as a combination of asphalt cement and a petroleum solvent. Typically, cut-backs are employed because they reduce asphalt viscosity for lower temperature uses, such as re-sealing coats, tack coats, fog seals, slurry seals, and for stabilization materials. After the cut-back asphalt is applied, the petroleum solvent evaporates leaving behind the asphalt cement residue upon the surface to which it was applied. The cut-back asphalt is said to ‘cure’ as the petroleum solvent evaporates away. Manufacturers and users of cutback asphalt products must be sensitive to increasingly stringent environmental regulations. The volatile chemicals of the cut-back solvents evaporate into the atmosphere, creating potential air emission issues.

Additionally, the petroleum solvents used in cut-backs typically require significant energy to manufacture and are expensive. Therefore, an alternative CMA product is needed that utilizes environmentally safe cut-back agents, being easily mixed and remaining viscous and usable for long period under a wide range of temperature conditions.

The following is a disclosure of the present invention that will be understood by reference to the following detailed description taken in conjunction with the accompanying drawing.

### BRIEF DESCRIPTION OF DRAWINGS

FIG. 1 is a schematic flow chart of a process for making a modified asphalt product, according to an embodiment of the invention;

FIG. 2 is a schematic flow chart of a process for making a modified asphalt product, according to an embodiment of the invention; and

FIG. 3 is a schematic flow chart of a process for making a modified asphalt product, according to an embodiment of the invention.

Reference characters included in the above drawing indicate corresponding parts, as discussed herein. The description herein illustrates one preferred embodiment of the invention, in one form, and the description herein is not to be construed as limiting the scope of the invention in any manner. It should be understood that the above listed figures are not necessarily to scale and that the embodiments may be illustrated by fragmentary views, graphic symbols, diagrammatic or schematic representations, and phantom lines. Details that are not necessary for an understanding of the present invention by one skilled in the technology of the invention, or render other details difficult to perceive, may have been omitted.

### DETAILED DESCRIPTION OF SPECIFIC EMBODIMENTS

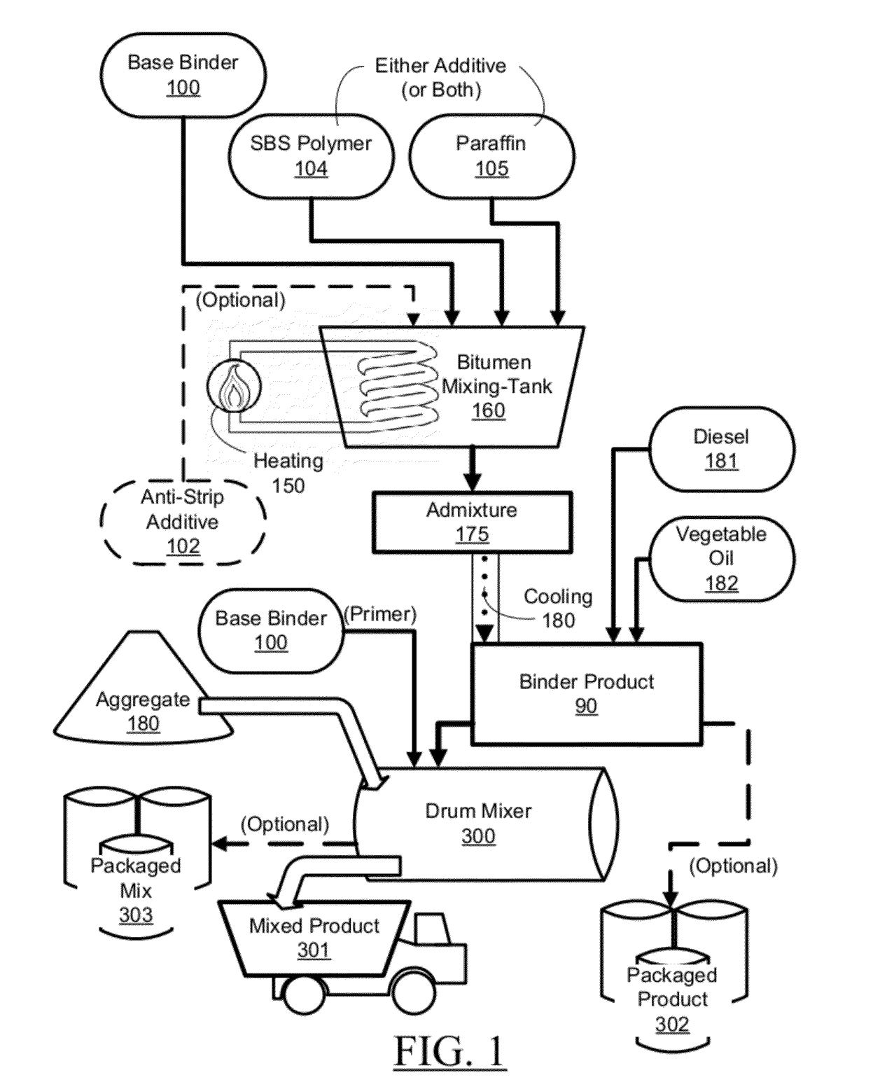

The invention provides an asphalt binder product, simply referred to herein as the “Product,” or “Binder Product” 90, as referenced in FIG. 1. The Binder Product is essentially a ‘cut-back’ bituminous binder, for use in the manufacture of cold mix asphalt “CMA” and asphalt treated base products. When mixed with an aggregate 180, the Product blends within the gradation ranges as typically specified by federal, state and local entities. As discussed further below, the Product may be employed as a patching/paving material or an asphalt treated base, either of which stays pliable for extended periods of time, and again meets the typical required specifications and standards, for stability, flow and ‘voids total mix,’ when tested as hot mix asphalt or asphalt treated base, in conformance with industry standard Hveem or Marshall Mix design methods.

Additionally, the present invention is directed to a process for preparing the asphalt Binder Product 90. Specifically, as shown in FIG. 1, the Product is produced by first heating a conventional and ‘regionally prescribed’ Base Binder 100, such as an ‘ASPHALT PG 64-22’ product, as manufactured by Paramount Petroleum of Paramount, Calif., or by Esso Imperial Oil of Ontario, Canada. The base binder is heated with or without adding a conventional Anti-Strip™ additive 102, to between 280 degrees F. and 475 degrees F., and then a powdered SBS polymer 104 is blended in, such as the ‘D1101KG-80’ product, as manufactured by Kraton Polymers of Houston, Tex. The SBS polymer is added at a ratio of approximately between 1% and 10% by weight of the base binder, optionally combined with a Paraffin 105 at a ratio of between 0.25% and 7% of the base binder, again by weight, as preferably fed into a standard bitumen type of Mixing-Tank 160, where the above referenced heating 150 is applied to the mixture and it is and blended until homogenous. The term “homogenous” is employed herein to denote a substantial uniformity in observable consistency and flow properties, as typically found acceptable in the pertinent industry for the subject materials.

The resultant Admixture 175 is then allowed to Cool 180 to between 100 degrees F. to 350 degrees F., and at which point a petroleum-based solvent or fuel such as conventional diesel 181, is added at a ratio between 15% and 40% of the total Binder Product weight, to form the Binder Product 90.

The terms “approximately” or “approximate” are employed herein throughout, including this detailed description and the attached claims, with the understanding that the terms denote a level of exactness as typical for the skill and precision in the generally applicable field of technology.

Alternatively to the petroleum-based solvent or fuel, referenced as ‘diesel’ 181 in FIG. 1, an Organic Oil 182 may be added to the admixture 175, instead. Specific oils employed as the Organic Oil in the Binder Product 90 may include: canola and corn oil. Other Organic Oils may include other vegetable oils, or animal derived oils or fats. These oils or fats considered for use in the Binder Product include: animal tallow, sunflower, safflower, and peanut oils. However, any readily available animal or vegetable derived oil product or mixture could be employed, either used alone, or in combination with the diesel.

Remarkably, a glycerol may be used as the Organic Oil 182. Glycerol a common name for propane-1,2,3-triol, and is also referred to as glycerine or glycerin. Glycerol is typically produced as a byproduct of bio-diesel manufacture, in the process of “transesterification.” Crude glycerin, as preferably used in an alternative formulation of the present invention, is often thick and dark, with a syrup-like consistency.

Most preferably, the Binder Product 90 is agitated until homogenous, with the Binder Product's end use application temperatures preferably between 70 degrees F. and 350 degrees F. The Binder Product may be further processed for immediate use in a hot Mixed Product 301, as discussed below, or simply containerized ‘as is’ in a Packaged Product 302. Also alternatively, as shown in FIG. 1, the Mixed Product can be containerized as a Packaged Mix 303.

As shown schematically in FIG. 1, the modified Binder Product 90 can be mixed with the Aggregate 180, as applied to a preestablished aggregate gradation, preferably at a ratio of between 3.0% and 8.0% by weight of total mix. A standard, heated type of drum mixer 300 can be employed in the processing of the Mixed Product 310, for an end use in surface repair and paving. As a less preferred alternative to the Drum Mixer, a conventional batch mixer is considered as an equivalent method of processing the Aggregate with the Binder Product.

Preferably, to prepare the Aggregate 180 for use, a raw aggregate is pre-dried through the Drum Mixer 300 at between 225 degrees F. and 350 degrees F., which is a typical temperature range in processing hot mix asphalt or “HMA.” The Aggregate is allowed to cool, and then run back through the Drum Mixer at approximately 140 degrees F. to 180 degrees F., and coated with the specified quantity of the modified oil Binder Product 90.

Alternatively, the Aggregate 180 can be processed and coated into the Drum Mixer 300 at higher temperatures, between 150 degrees F. and 350 degrees F., which is more typical of HMA processing, and coated with between 1% to 2% of the modified or alternatively unmodified (neat) Base Binder 100, by weight, in a first pass. The Mixed Product 301 is then allowed to cool to between ambient temperature and 160 degrees F., and then run back through the drum mixer without adding heat, where it is mixed with a final coat of Binder Product, to between 2% and 7% of modified oil Binder Product, by weight of total mix.

A more typical mix ratio of 0.5% to 5%, by weight of Binder Product 90 in the total mix, is most preferred for the Mixed Product 301, for use as an asphalt treated base, with post production handling temperatures for the Mixed Product most preferably between 70 degrees F. and 300 degrees F.

Preferably, the relative oil content of the Mixed Product 301 or the Binder Product 90 are established using the applicable Federal, State or local methods for asphalt and/or asphalt treated base. Additionally, these finished cold mix and the asphalt treated base products can be placed and compacted by hand, or with the aid of conventional equipment.

Furthermore, the Binder Product 90 and related end-products are observed to comply with all standards as tested, employing testing methods, gradations and value specifications per the recognized standards employed by the California Department of Transportation “Cal-Trans.” When the optimum or ‘best fit’ formulation is applied to federal, state, or locally specified gradations, the applicable Federal, State or local requirements for hot mix asphalt as applicable for low to high traffic roads, are achievable by the above described formulations. These specifications may include strength and stability, flow, and ‘voids total mix,’ as required.

When the Binder Product 90 formulations utilizing the Organic Oil 182 are applied to Federal, State or locally specified gradations, it was observed that the Product will meet the applicable Federal, State or local requirements for hot mix asphalt for stability, flow, and voids total mix when applicable, while substantially reducing environmental impact. Additionally, the above described product formulations can also be used to produce the asphalt treated base for the Binder Product 90. When the product is mixed with specific aggregate gradations in the Mixed Product 301, it can meet or exceed federal, state and local specifications for hot mix asphalt and for asphalt treated base. The Binder Product remains pliable and ready for use for months or years, when in the packaged Product 302 form, or simply stockpiled.

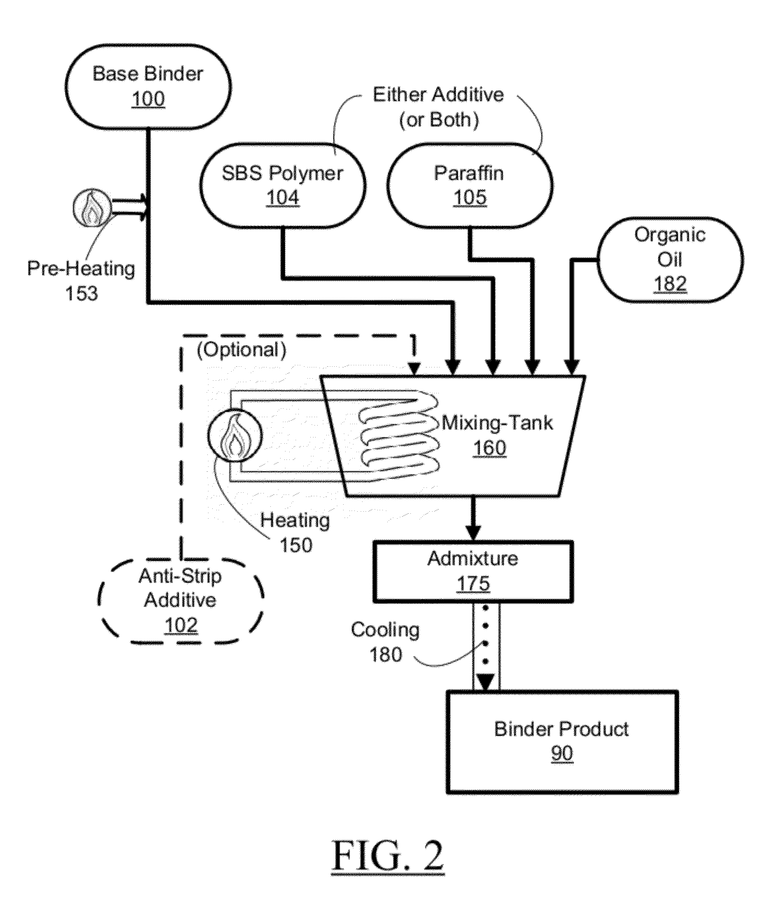

As shown in FIG. 2, in a preferred alternative to the processes for producing the Binder Product 90 described above, the Binder Product may be produced by first heating the Organic Oil 182, to between 250 degrees F. and 400 degrees F. This may be accomplished in the Mixing Tank 160. Alternatively, the Organic Oil can be pre-heated before transferring into the Mixing-Tank. The SBS Polymer 104 and/or the Paraffin 105 are then both or selectively added to the Organic Oil and blended until homogenous. The interim product can then be added to either the appropriate amount of a Base binder 100, or the Base Binder may be added to the interim product. To best blend with the interim product, the Base binder should undergo a Pre-Heating 153, to between 250 degrees F. and 350 degrees F. The Admixture 175 should be mixed within the Mixing-Tank at between 250 degrees F. and 350 degrees F., with the end-use temperature of the Binder Product 90 preferably between 70 degrees F. and 350 degrees F.

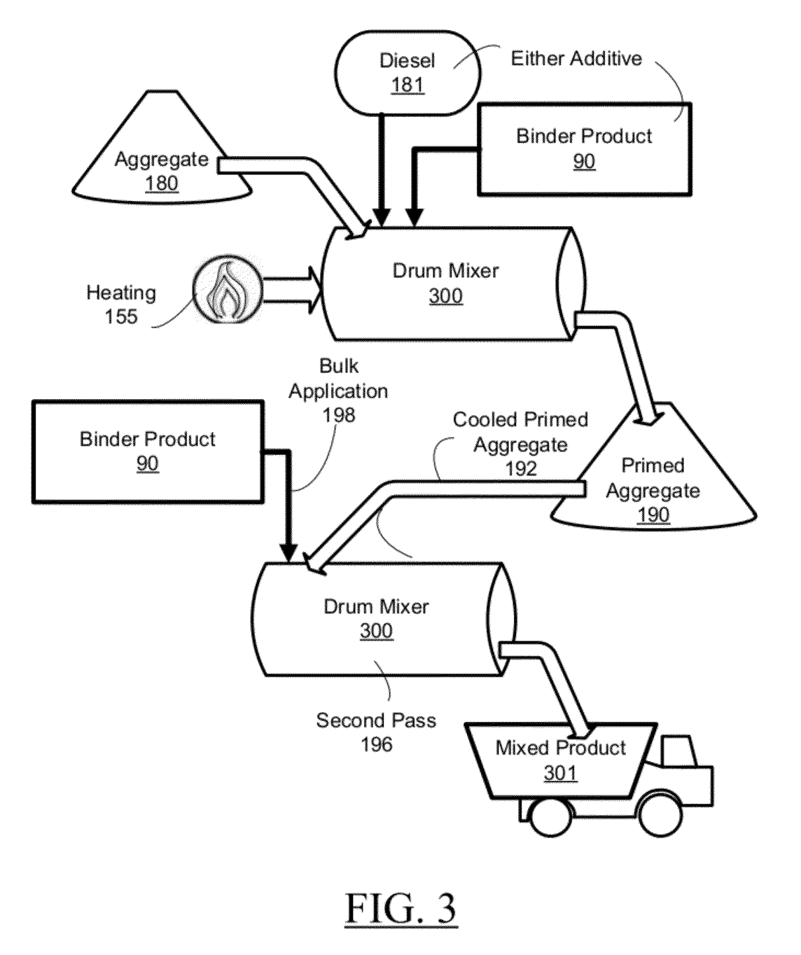

As shown in FIG. 3, in a preferred alternative to the processes for producing the Mixed Product 301, the Aggregate 180 is first dried and heated, preferably by a Heating 155 within the Drum Mixer 300, to between 150 degrees F. and 350 degrees, at which time the Aggregate is primed with preferably the Binder Product 90 or alternatively the Diesel 181, preferably at a rate of approximately 0.5% to 3% of the Aggregate, by weight. The resultant Primed Aggregate 190 is then allowed to cool to between ambient temperature to 250 degrees F., to form a Cooled Primed Aggregate 192. The Cooled Primed Aggregate can then be run back through the Drum Mixer 300, in a Second Pass 196, preferably with no additional heat added, and with the remaining quantity of Binder Product 90 added in a Bulk Application 198, to form the desired Mixed Product 301 formulation, as discussed above.

### A First Preferred Alternative Optimum Formulation and Production Ratios and Ranges:

1) Heat the asphalt Base Binder (PG 64-22), to 350 degrees F.
2) Add approximately 3% of the powdered SBS Polymer, (the Kraton Polymers' D1101KG-80 product), and approximately 0.5% of the Paraffin (Sasobit™), each percentage by weight of total resultant Admixture.
3) Blend the Admixture until homogenous, continuously heating at approximately 350 degrees F.
4) Allow Admixture to cool to 290 degrees F., then mix in 28% diesel fuel, by weight of total Binder Product.
5) In the Drum Mixer, initially blend the Aggregate with 1.5% asphalt base binder (PG 64-22) at 290 degrees F. The binder prepared Aggregate is then allowed to cool to below 150 degrees F., and then recycled back through the Drum Mixer, preferably with no additional heat applied. Generally, for a Cold Mix Product, 4.5% by weight Binder Product by weight of total mix, will then be applied. For an asphalt treated base Mixed Product, 1.5% Binder Product by weight of total mix will be applied, with the Binder Product temperature between 240 to 260 degrees F.

### A Second Preferred Alternative Optimum Formulation and Production Ratios and Ranges:

1) Heat a quantity of the Organic Oil equaling approximately 30% by weight of the total Binder Product to be produced, to approximately 320 degrees F.
2) In the Mixing-Tank, blend in the SBS Polymer, (most preferably Kraton Polymers'D1101KG-80 product) in an amount that is approximately 3% by weight of total Binder Product 90 to be produced.
3) Mix until homogenous.
4) Add the remaining required Base Binder (67% by total weight of the total Binder Product to be produced), the Base Binder preheated to 250 degrees F., and blend together.

### A Third Preferred Alternative Optimum Formulation and Production Ratios and Ranges:

1) Heat the Aggregate to approximately 250 degrees F.
2) Prime the heated Aggregate by mixing with the Binder Product at approximately 1.5% of the Binder Product by weight of the total mixture.
3) Stockpile the Primed Aggregate, and allowed to cool to 130 degrees F.
4) Run the Cooled Primed Aggregate back through the mixing process, most preferably without additional heating.
5) Add the remaining quantity of Binder Product, as needed, based on desired resultant Mixed Product formulation and specifications.

### A Fourth Preferred Alternative Optimum Formulation and Production Ratios and Ranges:

1) Heat Aggregate to between 200 degrees F. and 300 degrees F.
2) Coat the heated Aggregate by mixing with Binder Product at approximately 4% to 6.5% of the Binder Product by weight of the total Mixed Product.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

The following is claimed:

1. A method for formulating a binder product for mixing with an aggregate, the method comprising the steps of:
a) heating an asphalt base binder;
b) adding a SBS polymer and adding a paraffin, to form an admixture;
c) blending the admixture until substantially homogenous;
d) cooling the admixture; and
e) mixing with an organic oil to form the binder product.

2. The method for formulating the binder product of claim 1, wherein the organic oil mixed into the admixture is approximately 15% to 40%, by weight of the total binder product.

3. The method for formulating the binder product of claim 1, wherein the organic oil is a diesel fuel oil.

4. The method for formulating the binder product of claim 1, wherein the organic oil is an animal derived oil.

6. The method for formulating the binder product of claim 1, wherein the organic oil is a vegetable derived oil.

7. The method for formulating the binder product of claim 1, wherein the organic oil is a glycerol.

8. The method for formulating the binder product of claim 1, additionally including the step of:
f) blending the binder product with an aggregate to form a mixed product.

9. The method for formulating the binder product of claim 8, additionally including the step of:
priming the aggregate with approximately 0.5% to 5% by weight of the binder product by weight of a total mixed product, prior to adding the binder product to the aggregate.

10. The method for formulating the binder product of claim 8, additionally including the steps of:
g) cooling the aggregate after priming, before adding the binder product.

11. The method for formulating the binder product of claim 10, wherein the binder product is blended with the aggregate without additional heating.

12. A method for formulating a mixed aggregate product, the method comprising the steps of:
a) heating an asphalt base binder;
b) mixing in an organic oil to form the binder product; and
c) blending the binder product with an aggregate to form a mixed product.

13. The method for formulating the mixed aggregate product of claim 12, wherein the organic oil mixed into the admixture is approximately 15% to 40%, by weight of the total binder product.

14. The method for formulating the mixed aggregate product of claim 12, wherein the organic oil is a diesel fuel oil.

15. The method for formulating the mixed aggregate product of claim 12, wherein the organic oil is an animal derived oil.

16. The method for formulating the mixed aggregate product of claim 12, wherein the organic oil is a vegetable derived oil.

17. The method for formulating the mixed aggregate product of claim 12, wherein the organic oil is a glycerol.

18. The method for formulating the mixed aggregate product of claim 12, additionally including the steps of:
d) adding a SBS polymer to the base binder and adding a paraffin to the base binder to form an admixture, prior to blending the binder product with the aggregate; and
e) blending the admixture with a vegetable oil to form the binder product.

19. The method for formulating the mixed aggregate product of claim 12, additionally including the steps of:
d) adding a SBS polymer to the base binder and adding a paraffin to the base binder to form an admixture, prior to blending the binder product with the aggregate; and
e) blending the admixture with a diesel oil to form the binder product.
